(19) United States
(12) Patent Application Publication
(10) Pub. No.: US 2005/0072807 A1
(43) Pub. Date: Apr. 7, 2005

(54) Fluid dispenser device

(75) Inventor: Vivien Hsiao, Feng-Yuan City (TW)

Correspondence Address: Ladas & Parry, Suite 2100, 5670 Wilshire Boulevard, Los Angeles, CA, 90036-5679, US

(73) Assignee: Brooklands Enterprise Co., Ltd.

(21) Appl. No.: 10/692,928

(22) Filed: Oct. 23, 2003

(30) Foreign Application Priority Data
Sep. 16, 2003 (TW) 92216621

(51) Int. Cl. G01F 13/00

(52) U.S. Cl. 222/251

(57) ABSTRACT

A fluid dispenser device includes a tubular mount adapted to be fitted onto a top open end of a container, a volume variable member received in the mount and defining a passage therein, and a tubular plunger fluidly communicated with an outlet end of the passage and movable along the inner surface of the tubular mount so as to bring the outlet end to move toward a collapsed position to thereby squeeze fluid in the container out of the passage. Since the fluid is suctioned into the passage without contact with the inner surface of the tubular mount, the smooth movement of the plunger is ensured.

### BACKGROUND OF THE INVENTION

1. Field of the Invention

This invention relates to a fluid dispenser device, more particularly to a fluid dispenser device adapted for mounting at a top open end of a container containing fluid therein, especially liquid with grains suspended therein.

2. Description of the Related Art

Referring to FIG. 1, a conventional liquid dispenser device is shown to include a tubular mount 3 adapted for mounting at a top open end of a container 1 containing liquid therein and defining an accommodation chamber, a surrounding retaining cap 2 threadedly engaged to the top open end of the container 1, and a surrounding retaining collar 4 disposed on the surrounding retaining cap 2 so as to secure the tubular mount 3 to the top open end. A tubular plunger 5 is movable relative to the tubular mount 2, and has a passage fluid-tightly connected to and fluidly communicated with the accommodation chamber of the tubular mount 3 by means of a seal ring 503. Inlet and outlet valves 301,504 are disposed in an inlet of the accommodation chamber of the tubular mount 3 and an outlet of the passage of the plunger 5, respectively. A spout 6 is connected to the tubular plunger 5 for discharging liquid in the container 1. As such, referring to FIG. 2, depression of the plunger 5 can move the seal ring 503 downwards against biasing action of a spring 8 received in the accommodation chamber of the tubular mount 3 so as to squeeze the liquid and air out of the spout 6. A reduced pressure is created in the accommodation chamber once the seal ring 503 and the plunger 5 are returned to their original position by means of the spring 8, thereby suctioning the liquid in the container 1 through the inlet valve 301 to replenish the accommodation chamber.

The conventional liquid dispenser device can be applied to the container 1 for dispensing the liquid contained therein, such as liquid detergent, bath gel and shampoo. However, the conventional liquid dispenser device is not suitable for dispensing liquid with grains suspended therein because the grains may be trapped between the seal ring 503 and an inner surface of the tubular mount 3 to obstruct sliding movement of the seal ring 503 and to diminish the air-tight effect of the seal ring 503, thereby adversely affecting the movement of the plunger 5 and the biasing action of the spring 8.

### SUMMARY OF THE INVENTION

The object of the present invention is to provide a fluid dispenser device which can prevent wearing of component parts thereof and which can be operated smoothly.

According to this invention, the fluid dispenser device includes a tubular mount having a surrounding wall which surrounds an axis, which defines an accommodation chamber therein, and which has an upper surrounding portion that is adapted to be fitted in a top open end of a container, and a lower surrounding portion that is opposite to the upper surrounding portion and that has an intake port adapted for suction of fluid in the container therethrough.

A volume variable member is received in the accommodation chamber, and defines a passage therein, which extends along the axis. The passage includes an inlet end which is fluid-tightly secured to the lower surrounding portion and which is disposed in fluid communication with and downstream of the intake port, an outlet end which is disposed downstream of the inlet end and which is opposite to the inlet end along the axis, and an intermediate portion which is interposed between the inlet and outlet ends and which is configured such that the outlet end is movable between an expanding position, where the outlet end is away from the intake port so that the passage has a larger volume, and a collapsed position, where the outlet end is close to the intake port so that the passage has a smaller volume.

A tubular plunger has a surrounding plunger wall which defines a conduit therein. The plunger wall includes a surrounding depressing portion which is fluid-tightly secured to the outlet end of the passage such that the conduit is fluidly communicated with the passage, and which is movable relative to the surrounding wall of the tubular mount along the axis so as to bring the outlet end to move between the expanding and collapsed positions, and a surrounding actuated portion which extends from the surrounding depressing portion outwardly of the upper surrounding portion so as to be actuated to move the outlet end toward the collapsed position, thereby squeezing the fluid out of the passage and creating a reduced pressure in the passage once the outlet end is returned to the expanding position.

A biasing member is disposed to bias the outlet end towards the expanding position, thereby suctioning the fluid in the container through the intake port to replenish the passage by virtue of the reduced pressure created in the passage.

An inlet valve member is disposed upstream of the intake port. The inlet valve member permits the fluid in the container to flow into the passage of the volume variable member only, and prevents the fluid from flowing back into the container when the fluid in the passage is squeezed.

An outlet valve member is disposed downstream of the surrounding depressing portion of the conduit. The outlet valve member permits the fluid in the passage and the conduit to flow out through the conduit only when the fluid in the passage is squeezed, and helps create the reduced pressure in the passage by virtue of closure of the outlet valve member when the outlet end is returned to the expanding position.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is an axially sectional view of a conventional liquid dispenser device;

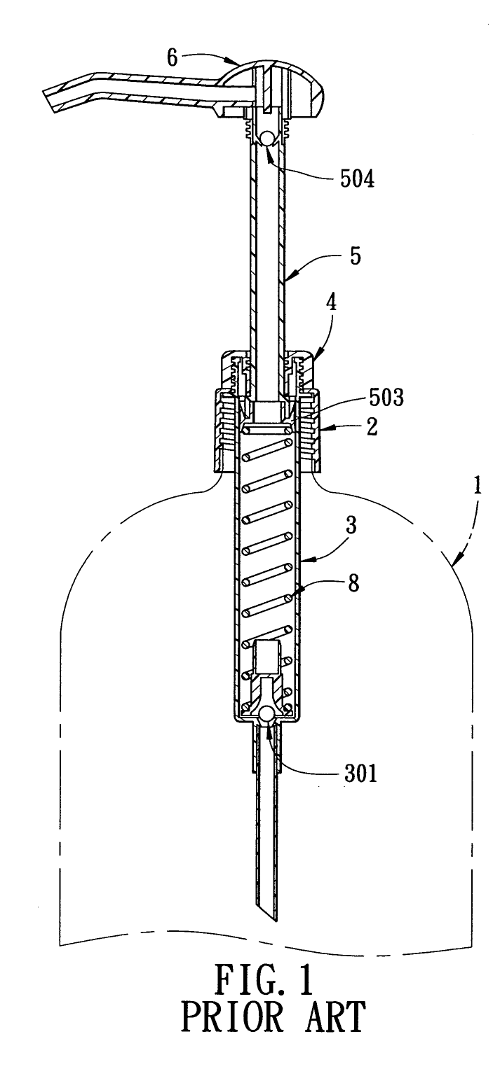

FIG. 2 is an axially sectional view of the conventional liquid dispenser device in a depressed state;

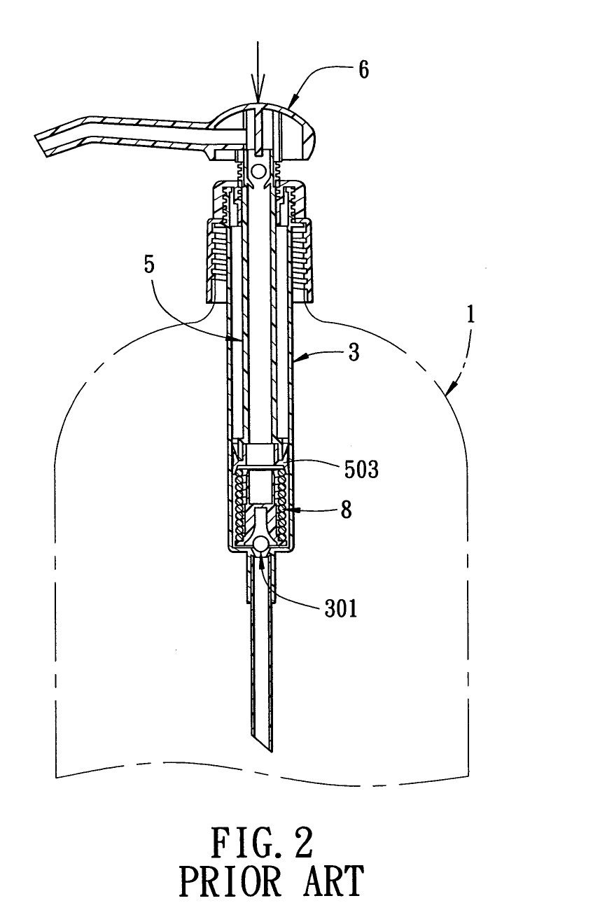

FIG. 3 is an exploded plan view of the preferred embodiment of a fluid dispenser device according to this invention;

FIG. 4 is an axially sectional view of the preferred embodiment; and

FIG. 5 is an axially sectional view of the preferred embodiment in a depressed state.

### DETAILED DESCRIPTION OF THE PREFERRED EMBODIMENT

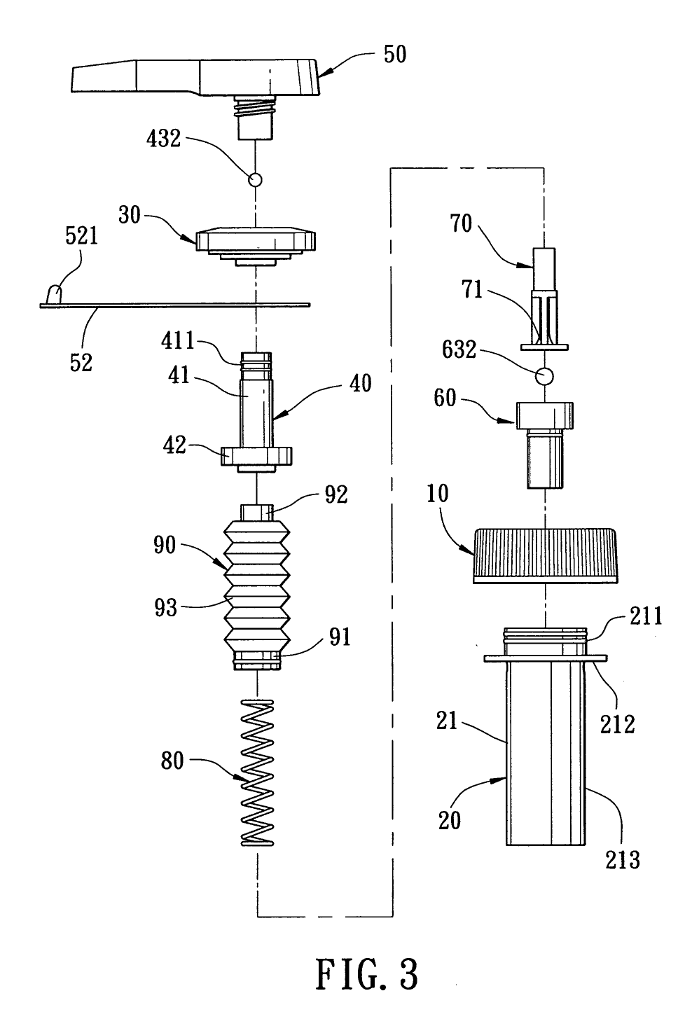

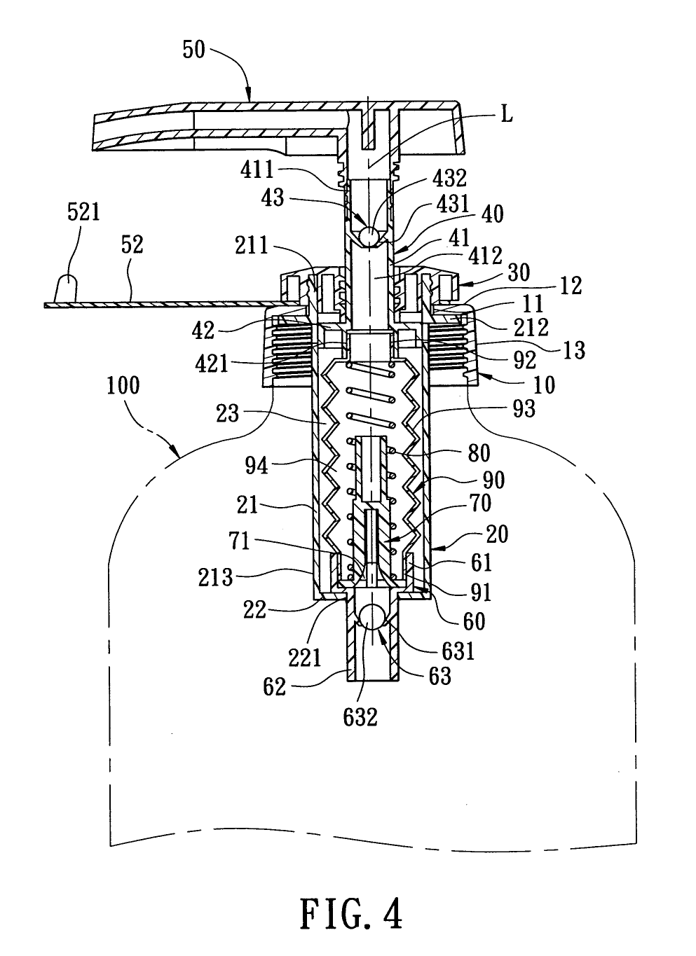

Referring to FIGS. 3 and 4, the preferred embodiment of a fluid dispenser device according to the present invention is shown to be adapted for mounting at a top open end of a container 100 containing liquid therein, such as shampoo, liquid detergent with scrubbing grains suspended therein, etc. The fluid dispenser device is shown to comprise a tubular mount 20, a surrounding retaining cap 10, a surrounding retaining collar 30, a dipping tube 60, a volume variable member 90, a biasing member 80, a tubular plunger 40, and a spout 50.

The tubular mount 20 has a surrounding wall 21 which surrounds an axis (L), which defines an accommodation chamber 23 therein, and which has an upper surrounding portion 211 and a lower surrounding portion 213 opposite to each other. A radially extending flange 212 extends from the upper surrounding portion 211 radially and outwardly, and is adapted to be mounted on the top open end of the container 100. The retaining cap 10 has a surrounding top wall 12 which defines a circular hole 11 therein and which has a periphery, and a surrounding threaded wall 13 which extends downwardly from the periphery of the surrounding top wall 12. The upper surrounding portion 211 of the surrounding wall 21 of the tubular mount 20 passes through the circular hole 11 such that the top wall 12 is disposed on the radially extending flange 212. The threaded wall 13 is engaged threadedly with the top open end of the container 100. The surrounding retaining collar 30 is press-fitted onto the upper surrounding portion 211 so as to force the radially extending flange 212 to abut against the top wall 12, thereby securing the tubular mount 20 to the container 100.

The lower surrounding portion 213 has a bottom wall portion 22 which defines an intake port 221 adapted for suction of the fluid in the container 100 therethrough.

The dipping tube 60 has a connecting portion 61 which is connected to and which is fluidly communicated with the lower surrounding portion 213, and a tube portion 62 which extends downwardly from the connecting portion 61 and which is adapted to dip into the liquid in the container 100. An inlet valve member 63 includes a valve seat 631 which is formed integrally with the tube portion 62 and which extends towards the axis (L) in radial directions, and a ball 632 which is detachably engaged with the valve seat 631 so as to open and close the valve seat 631. A porous member 71 is disposed on the connecting portion 61 so as to deny entry of the ball 632 into the accommodation chamber 23. A tubular stem 70 extends from the porous member 71 along the axis (L).

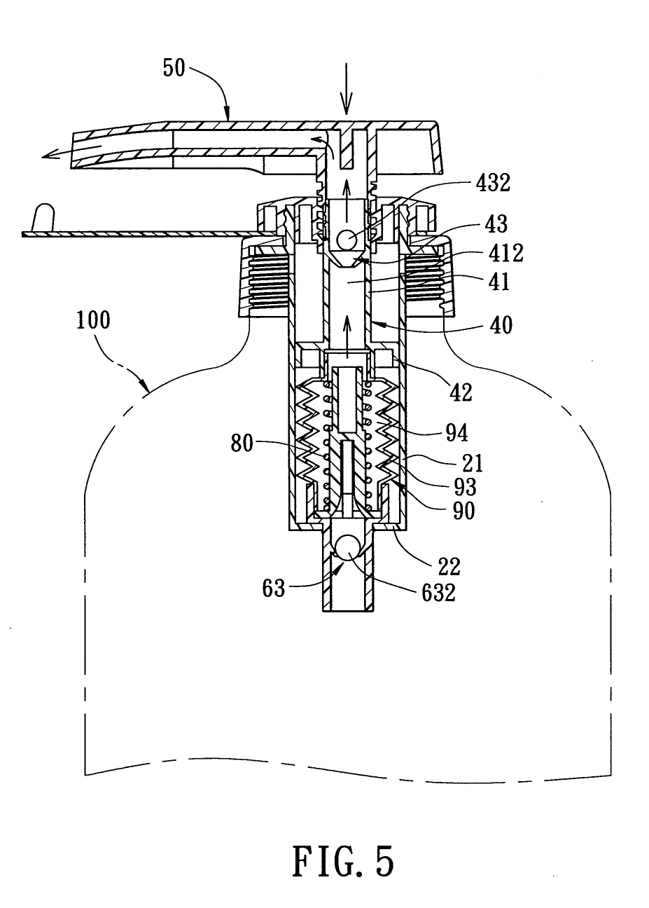

The volume variable member 90 is made from a flexible material, and is configured to have a bellows shape. The volume variable member 90 is received in the accommodation chamber 23, and defines a passage 94 therein, which extends along the axis (L). The passage 94 includes an inlet end 91 which is fluid-tightly secured to the connecting portion 61 and which is disposed in fluid communication with and downstream of the intake port 221, an outlet end 92 which is disposed downstream of the inlet end 91 and which is opposite to the inlet end 91 along the axis (L), and an intermediate portion 93 which is interposed between the inlet and outlet ends 91,92 and which is configured such that the outlet end 92 is movable between an expanding position, where the outlet end 92 is away from the intake port 221 so that the passage 94 has a larger volume (as shown in FIG. 4), and a collapsed position, where the outlet end 92 is close to the intake port 221 so that the passage 94 has a smaller volume (as shown in FIG. 5).

The biasing member 80 is a coil spring 80 which is received in the passage 94 and which is sleeved on the tubular stem 70 so as to firmly bias the outlet end 92 towards the expanding position.

The tubular plunger 40 has a surrounding plunger wall 41 which defines a conduit 412 therein. The plunger wall 41 includes a surrounding depressing portion 421 which is fluid-tightly secured to the outlet end 92 of the passage 94 such that the conduit 412 is fluidly communicated with the passage 94, a surrounding flange portion 42 which extends outwardly and radially from the surrounding depressing portion 421 such that the surrounding flange portion 42 is in slidable contact with an inner surface of the surrounding wall 21 of the tubular mount 20 so as to stabilize the movement of the outlet end 92 along the axis (L) between the expanding and collapsed positions, and a surrounding actuated portion 411 which extends from the surrounding depressing portion 421 along the axis (L) and outwardly of the surrounding retaining collar 30.

The spout 50 is connected to the surrounding actuated portion 411, and is fluidly communicated with the conduit 412 for discharging the liquid from the conduit 412. Preferably, a flexible strap 52 has one end retained between the surrounding retaining cap 10 and the surrounding retaining collar 30, and the other end provided with a stopper 521 which is disposed to detachably plug the spout 50 so as to prevent flow of the liquid through the spout 50 when the container 100 is unintentionally squeezed.

In this embodiment, like the inlet valve member 63, an outlet valve member 43 includes a valve seat 431 which is formed integrally with the surrounding plunger wall 41 at a position between the surrounding depressing portion 421 and the surrounding actuated portion 411, and which extends towards the axis (L) in radial directions, and a ball 432 which is detachably engaged with the valve seat 431 so as to open and close the valve seat 431.

As shown in FIG. 5, when the spout 50 is depressed against biasing action of the coil spring 80 to actuate the tubular plunger 40 so as to move the outlet end 92 of the volume variable member 90 toward the collapsed position, the grain-containing liquid and air inside the container 100 are squeezed up the passage 94, the conduit 412 and the outlet valve member 43 for discharging through the spout 50. During this operation, the ball 432 of the outlet valve member 43 is lifted to thereby open the valve seat 431, while the ball 632 of the inlet valve member 63 closes the valve seat 631 to prevent the liquid from flowing back into the container 100.

When the spout 50 is released, the outlet end 92 is returned to the expanding position by virtue of the biasing action of the coil spring 80, thereby creating a reduced pressure in the passage 94 and the conduit 412. At this time, the liquid in the container 100 is suctioned through the inlet valve member 63 and the porous member 71 to replenish the passage 94 and the conduit 412 by virtue of the reduced pressure for a next dispensing operation. At the same time, the ball 432 of the outlet valve member 43 closes the valve seat 431 so as to help maintain the reduced pressure.

Since the liquid in the container 100 is suctioned into the passage 94 of the volume variable member 90 and does not contact the surrounding wall 21 of the tubular mount 20, the inner surface of the surrounding wall 21 will not be subject to the grinding action of the grains suspended in the liquid, thereby ensuring the smooth sliding movement of the surrounding flange portion 42 along the inner surface of the surrounding wall 21 and the biasing movement of the coil spring 80. The service life of the tubular mount 20, the tubular plunger 40 and the coil spring 80 can be thus prolonged.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

1. A fluid dispenser device adapted for mounting at a top open end of a container containing fluid therein, said fluid dispenser device comprising:
a tubular mount having a surrounding wall which surrounds an axis, which defines an accommodation chamber therein, and which has an upper surrounding portion that is adapted to be fitted in the top open end of the container, and a lower surrounding portion that is opposite to said upper surrounding portion and that has an intake port adapted for suction of the fluid in the container therethrough;
a volume variable member received in said accommodation chamber, and defining a passage therein which extends along the axis, said passage including an inlet end which is fluid-tightly secured to said lower surrounding portion and which is disposed in fluid communication with and downstream of said intake port, an outlet end which is disposed downstream of said inlet end and which is opposite to said inlet end along the axis, and an intermediate portion which is interposed between said inlet and outlet ends and which is configured such that said outlet end is movable between an expanding position, where said outlet end is away from said intake port so that said passage has a larger volume, and a collapsed position, where said outlet end is close to said intake port so that said passage has a smaller volume;
a tubular plunger having a surrounding plunger wall which defines a conduit, said plunger wall including a surrounding depressing portion which is fluid-tightly secured to said outlet end of said passage such that said conduit is fluidly communicated with said passage, and which is movable relative to said surrounding wall of said tubular mount along the axis so as to bring said outlet end to move between the expanding and collapsed positions, and a surrounding actuated portion which extends from said surrounding depressing portion outwardly of said upper surrounding portion so as to be actuated to move said outlet end toward the collapsed position, thereby squeezing the fluid out of said passage and creating a reduced pressure in said passage once said outlet end is returned to the expanding position;
a biasing member disposed to bias said outlet end towards the expanding position, thereby suctioning the fluid in the container through said intake port to replenish said passage by virtue of the reduced pressure created in said passage;
an inlet valve member disposed upstream of said intake port, said inlet valve member permitting the fluid in the container to flow into said passage of said volume variable member only, and preventing the fluid from flowing back into the container when the fluid in said passage is squeezed; and
an outlet valve member disposed downstream of said surrounding depressing portion of said tubular plunger, said outlet valve member permitting the fluid in said passage and said conduit to flow out through said conduit only when the fluid in said passage is squeezed, and helping create the reduced pressure in said passage by virtue of closure of said outlet valve member when said outlet end is returned to the expanding position.

2. The fluid dispenser device of claim 1, wherein said intermediate portion of said passage of said volume variable member is made from a flexible material, and is configured to have a bellows shape.

3. The fluid dispenser device of claim 1, further comprising a dipping tube which is connected to and which is fluidly communicated with said lower surrounding portion, and which is adapted to dip into the fluid in the container, said inlet valve member including a valve seat which is formed integrally with said dipping tube and which extends towards the axis in radial directions, and a ball which is detachably engaged with said valve seat so as to open and close said valve seat by virtue of a pressure difference between said passage and the fluid.

4. The fluid dispenser device of claim 3, further comprising a porous member which is disposed on said lower surrounding portion so as to deny entry of said ball into said passage while permitting flow of the fluid in the container into said passage.

5. The fluid dispenser device of claim 4, further comprising a tubular stem which extends from said porous member along the axis, said biasing member being a coil spring which is received in said passage, and which is sleeved on said tubular stem such that the biasing movement of said coil spring is stabilized.

6. The fluid dispenser device of claim 1, wherein said outlet valve member includes a valve seat which is formed integrally with said surrounding plunger wall at a position between said surrounding depressing portion and said surrounding actuated portion and which extends towards the axis in radial directions, and a ball which is detachably engaged with said valve seat so as to open and close said valve seat by virtue of squeezing of the fluid.

7. The fluid dispenser device of claim 1, wherein said tubular plunger further has a surrounding flange portion which extends outwardly and radially from said surrounding depressing portion such that said surrounding flange portion is in slidable contact with said surrounding wall of said tubular mount, thereby stabilizing movement of said outlet end along the axis between the expanding and collapsed positions.

8. The fluid dispenser device of claim 1, wherein said tubular mount further includes a radially extending flange which extends from said surrounding wall radially and outwardly and which is adapted to be mounted on the top open end of the container,
said fluid dispenser device further comprising
a surrounding retaining cap which has a surrounding top wall that has a periphery and that is disposed on said radially extending flange, and a surrounding threaded wall that extends downwardly from said periphery of said surrounding top wall and that is adapted to engage threadedly the top open end of the container, and
a surrounding retaining collar which is engaged with said upper surrounding portion so as to force said radially extending flange to abut against said surrounding top wall of said surrounding retaining cap, thereby securing said tubular mount onto the container.

9. The fluid dispenser device of claim 8, further comprising a spout which is connected to said surrounding actuated portion and which is fluidly communicated with said conduit for discharging the fluid squeezed up said conduit.
